(19) United States
(12) Patent Application Publication
(10) Pub. No.: US 2020/0108919 A1
(43) Pub. Date: Apr. 9, 2020

(54) Quiet Redundant Rotorcraft

(71) Applicant: Jaime Guillermo Sada, San Antonio, TX (US)

(72) Inventors: Jaime Guillermo Sada, San Antonio, TX (US); David Alejandro Arellano Escarpita, Durango (MX)

(21) Appl. No.: 16/655,196

(22) Filed: Oct. 16, 2019

Related U.S. Application Data
(60) Provisional application No. 62/476,696, filed on Mar. 24, 2017.

(51) Int. Cl. B64C 27/82; B64C 27/20; B64C 27/10; B64D 27/24

(52) U.S. Cl. CPC B64C 27/82; B64C 27/20; B64C 27/10; B64C 2027/8209; B64C 2027/8227; B64C 2027/8272; B64C 2027/8236; B64D 27/24

(57) ABSTRACT

Provided is a quiet redundant urban rotorcraft, commonly known as urban air mobility eVTOL. The quiet redundant urban rotorcraft is designed to perform vertical takeoff and landings powered by two independent electric lifting motors. The lifting force is distributed among counter-rotating, co-axial main multi-bladed rotors and several smaller rotors distributed around the vehicle which provide attitude control during hover and low speed flight. The quiet redundant urban rotorcraft is capable to fly at relatively high horizontal speed by using a dedicated horizontal thrust propeller driven by an electric motor, turbine or internal combustion engine. In high speed flight, the main rotors turn freely, the control electric motors turn off and the attitude control is provided by aerodynamic fixed and moving surfaces. The quiet redundant urban rotorcraft has a low noise footprint and multiple redundancy for safety, while at the same time having a compact configuration for operating area restrictions.

### FIELD

The present disclosure relates to the field of rotorcrafts. In particular, the present disclosure relates to a rotorcraft that is designed to have vertical take-off and landing while being as quiet and safe as technically possible.

### BACKGROUND

A rotorcraft is an aircraft that uses the lift generated by a plurality of rotor blades that revolve around a mast. Depending upon the number of rotors, configurations and powering, the rotorcrafts can be broadly classified as a helicopter, a cyclocopter, a multicopter, a gyrocopter, a gyrodyne, and so on.

The use of a rotorcrafts for short distance urban commuting is limited by the fact that typical rotorcraft are extremely noisy There is, therefore, a need of a rotorcraft that is designed to be as quiet as possible to be allowed to operate within urban environments.

### SUMMARY

The present invention is directed towards a rotorcraft having the lowest possible noise footprint and the greatest safety, while also being very compact, very inexpensive to own and maintain and easy to operate at the same time.

In accordance with the present invention, the rotorcraft comprises a cockpit. The cockpit can be configured to accommodate just a pilot or a pilot and one or more passengers. In a preferred embodiment, the rotorcraft is a two-seater aircraft, i.e., the cockpit is designed to accommodate the pilot and one more passenger other than the pilot.

In one embodiment, the rotorcraft further comprises a mast extending from the operative top end of the cockpit. The mast is configured to house a pair of concentric shaft electric motors in vertical tandem configuration. The motors can be configured to differentially control the overhead counter-rotating pair of rotors. The rotor is configured to support a set of blades, and the rotorcraft comprises two such sets of blades, whose number and shape will depend on the need to meet the noise limitation requirements. In a preferred embodiment, the blades are many and of low aspect ratio blades with wide blade chords to reduce the tip speed as much as possible, while maintaining the same lift as traditional helicopters, and reducing, therefore, the noise footprint.

In another embodiment, the rotorcraft further comprises a plurality of electric vertically pointed or vertical-horizontal pivoting fans for controlling the yaw, pitch, and roll of the rotorcraft and providing additional thrust if they are constructed in a way to allow them to pivot. More specifically, the rotorcraft includes wing like extensions within which the electric fans are installed, i.e., the electric fans are fitted within the extensions such that the extensions function as fairing shrouds for the electric fans and also function as barriers for noise abatement.

In another embodiment, the rotorcraft comprises vertical stabilizers and rudders provided on each of the tail wing fan extensions. Similarly, the extensions are also provided with horizontal stabilizers and elevators. The stabilizers facilitate the horizontal as well as vertical stabilization of the rotorcraft in an operative configuration thereof when airspeed is sufficient and therefore, while at speed there is no need for powering the fans.

In another embodiment, the rotorcraft further comprises a horizontal propeller fan provided at a rear operative end of the rotorcraft. In accordance with one embodiment, the horizontal propeller fan is powered by an internal combustion engine for models for the rotorcraft designed for longer commutes. For models of the rotorcraft designed for shorter urban commutes, the horizontal propeller fan is powered by an electric motor. In yet another embodiment, the horizontal propeller fan is powered by a fuel turbine generator for obtaining higher reliability than an internal combustion engine and higher range than electric batteries. The horizontal propeller fan is contained within a ducted shroud. The shroud helps in reducing the noise footprint of the rotorcraft. In another embodiment, the shroud may have moving surfaces for thrust vectoring.

During the takeoff and landing phases, the rotorcraft operates in a manner that is similar to a counter rotating rotors helicopter but in this case the stability and attitude are controlled like an electric multi-copter. More specifically, during vertical take-off and landing, the rotorcraft is powered by the two sets of blades that are supported on the at least one rotor, and the stability and navigation direction is controlled by the electric fans. During the take-off phase, once the rotorcraft reaches a specific height the horizontal propeller fan is then powered to push the rotorcraft in the operative horizontal direction and once it reaches a certain speed, the power supply to the two sets of blades is then cut off but they continue to rotate like a helicopter's autorotation mode. In this state, called the gyrocopter (autorotation) flight phase, the blades are in a freewheeling state. During the cruise speed regime, the control moving surfaces perform the control in pitch, yaw and roll. The roll control is performed by differential horizontal elevator surface control and all of these actions can be augmented by the use of the fans, if the speed is insufficient. During very slow flight such as in take-off and landing operative conditions, the horizontal propeller fan can be mildly active for pushing the rotorcraft forward, while the electric fans are activated either collectively or at least one at a time to control the yaw, pitch, and roll of the rotorcraft. While at slow speeds the counter rotating main rotors can be controlled differentially to control yaw and/or the electric fans may swivel towards a horizontal vectoring to perform the yaw control if one of the main rotors electric motors fails. During the gyrocopter (autorotation) flight, the rudders and elevators provides aerodynamic control. After reaching the destination, the main rotor blades are activated again for allowing the rotorcraft to perform a precision vertical landing with full 3D control similar but better than a helicopter

Alternatively and in case there is a double main engine failure or if there is a runway at either end of the flight, the aircraft can be airborne or land in autogyro mode without any power to the main rotors. It seamlessly converts from helicopter to gyrocopter back and forth without the need to adjust the rotor pitch setting that helicopters perform while transitioning from powered mode to autorotation mode back and forth.

The dual sets of controls, one conventional aerodynamic and the other with 4 or more single or tandem electric fans, plus the dual main rotor electric motors, assures absolute and unprecedented redundancy for safety. If configured with partially horizontally pivoting wing extension fans, a failure of one of the main engines and its normally fatal torque effect is counteracted by differential fan power.

### BRIEF DESCRIPTION OF DRAWING

The aspects and other features of the subject matter will be better understood with regard to the following description, appended claims, and accompanying figures. In the figures, the left-most digit(s) of a reference number identifies the figure in which the reference number first appears. The use of the same reference number in different figures indicates similar or identical items.

FIG. 1A illustrates an isometric view of a rotorcraft, in accordance with an embodiment of the present invention.

FIG. 1B illustrates a top view of the rotorcraft, in accordance with an embodiment of the present invention.

FIG. 1C illustrates a side view of the rotorcraft, in accordance with an embodiment of the present invention.

### DETAILED DESCRIPTION

As stated previously in the present disclosure, there is need for a rotorcraft that has a lower noise footprint while at the same time having a compact configuration suitable for inter-urban commutes, which require vertical or extremely short take-off and landing.

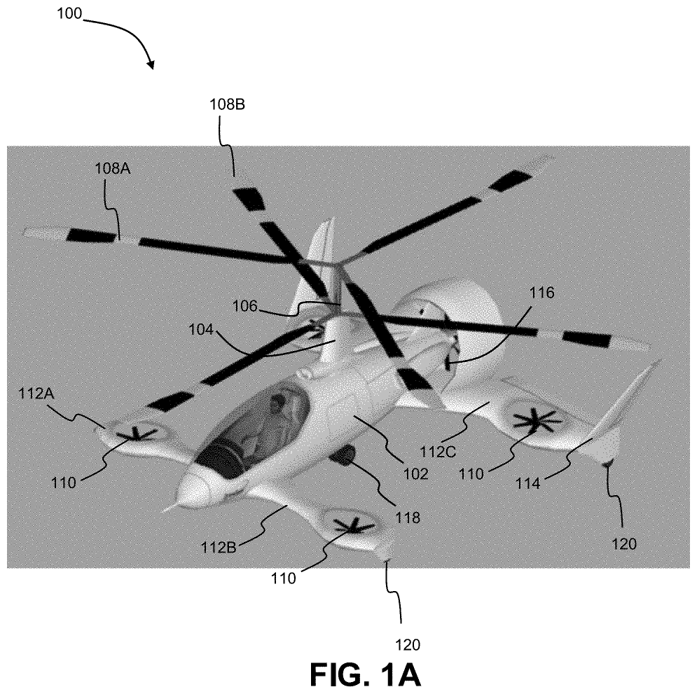

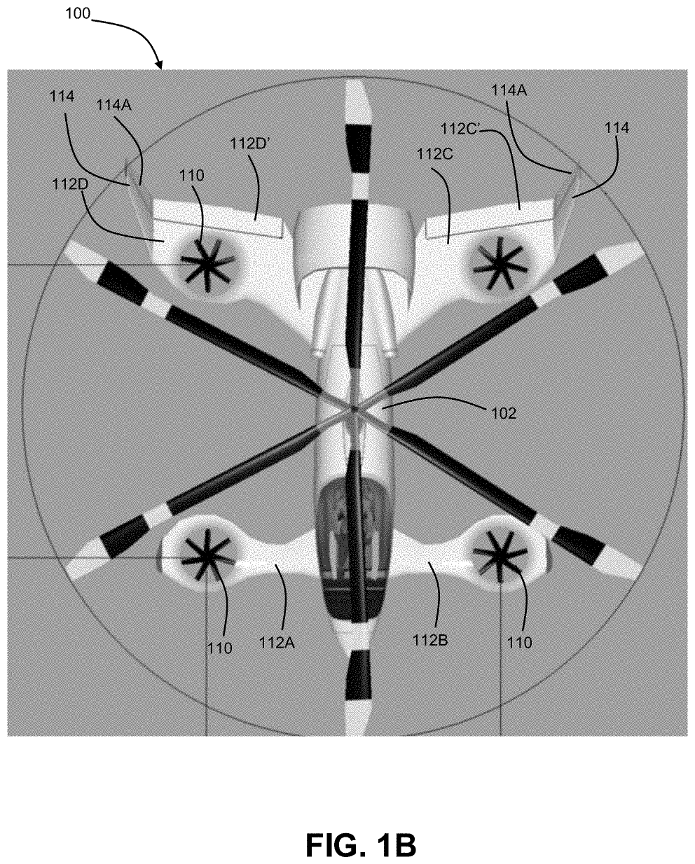

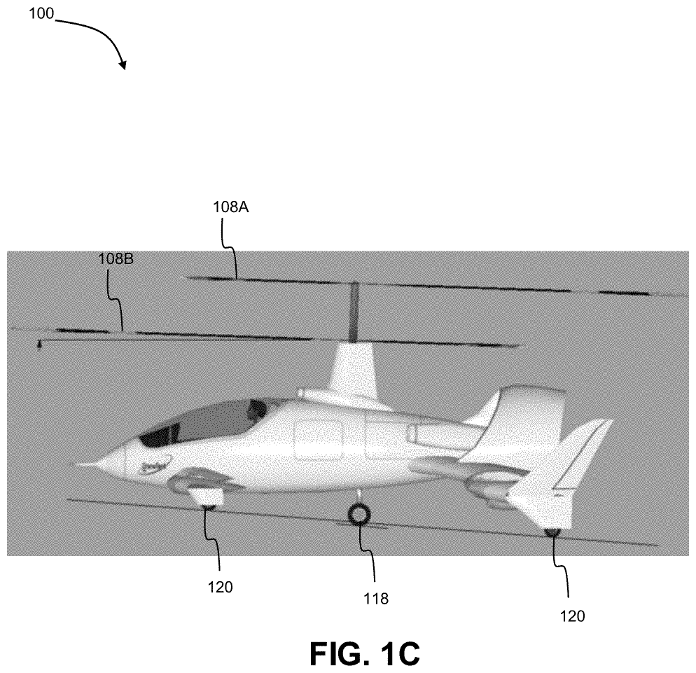

In accordance with the present invention, the elimination of the complicated, failure and maintenance prone and heavy tail rotor, swash plate, lead-lag devices, linkages, transmission and the collective and cyclical mechanisms are unnecessary and so the invention proposes the use of a fixed pitch main rotors system. Reference hereinafter is directed to FIG. 1A thru FIG. 1C.

A single seat rotorcraft version named “100”, in accordance with an embodiment of the present invention, is illustrated in FIG. 1A thru FIG. 1C. The rotorcraft 100 comprises a cockpit 102. The cockpit 102 can be configured to house the pilot and one or more passengers. In accordance with a preferred embodiment of the present invention, the rotorcraft 100 is designed for allowing commute of a pilot and a passenger.

The rotorcraft 100 further comprises a pair of concentric motors (not shown in figures) disposed within a base of a mast 104 of the rotorcraft 100. At least one rotor 106 extends from the mast 104 for supporting two sets of blades 108A, 108B. Each set of blades 108A, 108B includes three blades. The motors are powered with appropriate batteries to power the main rotors 106 during the take-off and landing phases.

The rotorcraft 100 further comprises a plurality of electric fans 110 for controlling the yaw, pitch, and roll of the rotorcraft 100. More specifically, the rotorcraft 100 includes wing like extensions 112A-112D within which the electric fans 110 are installed, i.e., the electric fans 110 are fitted within the extensions 112A-112D such that the extensions 112A-112D function as shrouds for the electric fans 110. The main function of the extensions 112A-112D is to support the electric fans 110 and place the electric fans 110 at such a distance that they have enough lever arm. In horizontal flight, the extensions 112A-112D will create some additional lift and stability, but it is desired to minimize the area as much as possible so that it does not interfere with the downwash of the main rotors in helicopter flight mode or take-off/landing mode. In an embodiment, both the main rotors 106 and the electric fans 110 are powered with high power density batteries, which contain enough power for no more than 4-6 minutes of flight, with a reserve capacity of 25%.

The rotorcraft 100 further comprises a vertical stabilizer 114 provided on each of the extensions 112C, 112D. The vertical stabilizer 114 is provided with a rudder 114A, which provides directional control in the autorotation flight phase. Similarly, the extensions 112C, 112D are also provided with control surfaces, so called elevators 112C′, 112D′, which provide pitch and roll control during the autorotation flight phase.

The rotorcraft 100 further comprises a horizontal propeller fan 116 provided at a rear operative end of the rotorcraft 100. In accordance with one embodiment, the horizontal propeller fan 116 is powered by an internal combustion engine for models of the rotorcraft 100 designed for longer commutes. For models of the rotorcraft 100 designed for shorter urban commutes, the horizontal propeller fan 116 is powered by an electric motor. In yet another embodiment, the horizontal propeller fan 116 is powered by a fuel turbine generator for obtaining higher reliability than an internal combustion engine or electric batteries. The horizontal propeller fan 116 is a shrouded fan. The shroud helps in reducing the noise footprint of the rotorcraft 100. In accordance with one exemplary implementation, for a single seat version the estimated power requirement for a single-seater rotorcraft ranges from 60 hp to 80 hp for driving a fixed-pitch, six-blade ringed propeller with a diameter of 1.17 m. The horizontal propeller fan 116 would be fixed pitch optimized for the estimated cruising speed, in the order of 80-100 KIAS, as the acceleration distance to reach gyrocopter flight speed is of no concern.

The operative configurations of the rotorcraft 100 is hereinafter described. The rotorcraft 100 operates in a first operative configuration during take-off and landing. In the first operative configuration, the rotorcraft 100 operates in a manner that is similar to a helicopter combined with multi-copter fan control. More specifically, during vertical take-off and landing, the rotorcraft 100 is powered by the two sets of blades 108A, 108B that are supported on the at least one rotor 106, and the take-off and landing motion is controlled by the electric fans 110. Once the rotorcraft 100 reaches a specific height, the horizontal fan 116 accelerates the rotorcraft up to the flight speed and the power supply to the two sets of blades 108A, 1088 is then cut off. In this state, the blades 108A, 108B are in a freewheeling state. In certain operative conditions, the horizontal propeller fan 116 is active for pushing the rotorcraft 100 forward, while the electric fans 110 are activated either collectively or at least one at a time to control the yaw, pitch, and roll of the rotorcraft 100. After reaching the destination, the blades 108A, 108B are activated again for allowing the rotorcraft 108 to perform a vertical landing.

In one working embodiment, for providing the vertical lift, the blades 108A, 1088 and the electric fans 110 are operated in tandem via electric motors and battery power. Given the short period of time it takes to climb and accelerate to cruise mode (typically less than 1 minute), an electric motor and Lithium Polymer battery combination proves to be the least noisy, lightest, most reliable, and a low maintenance solution. For short endurance flights, the batteries may not be recharged inflight. Li-Po battery safety may be addressed with a sealed metallic container with nitrogen or even with exhaust gases pumped into the sealed container to prevent entry of any oxygen inside the metallic container, thus avoiding the much-feared fire hazard danger.

The rotorcraft 100, in accordance with an embodiment of the present invention, is configured for vertical or take-off and landing. More specifically, the use of the blades 108A, 108B facilitate the operation of the rotorcraft 100 in a manner similar to a helicopter, thereby significantly reducing the space required for take-off and landing. The advantage of such an embodiment is that it facilitates achieving a substantial saving in battery weight, and thus, gaining in useful load. The term useful load refers to payload and energy source, wherein the energy source is either fuel or horizontal thrust batteries. In accordance with the instant embodiment, the rotorcraft 100 can take-off or land vertically or, in gyrocopter mode only, a strip on a short track as well, the length of which ranges in the order of less than 100 meters.

In accordance, with another embodiment, the rotorcraft 100 is configured for vertical take-off and landing.

The focus of the present invention does not lie in maximizing speed or efficiency of the rotorcraft 100. Rather, most of the features of the present invention are directed towards reducing the noise footprint of the rotorcraft 100 while in flight and more importantly, during the vertical take-off and landing of the rotorcraft 100.

In accordance with the present invention, the blades 108A, 108B supported on the at least one rotor 106 are powered for a single seagt version by two 40 hp electric motors, or two 80 hp motors for utmost redundancy. These electric motors are counter-rotating motors that are disposed within the mast 104 of the rotorcraft 100. The at least one rotor 106 can be differentially controlled for yaw control in vertical flight mode. As discussed previously, as the rotorcraft 100 accelerates to a transition speed ranging from 30-40 KIAS, the motors are deactivated for allowing the at least one rotor 106 and the blades 108A, 1088 to rotate freely, as in an autogyro, providing almost all the lift. In one other embodiment, the rotorcraft 100 can be designed to use the freewheeling motion of the blades 108A, 1088 to power generators disposed within the rotorcraft 100 for providing power to the electronic systems on board the rotorcraft 100, which have a comparatively low power consumption. In one embodiment, blades 108A, 1088 have a fixed pitch of 3° with respect to the plane of the rotor, while the plane of the blades 108A, 108B has an incidence of 2°.

In an embodiment, the electric fans 110 are independently controllable to provide pitch and roll control in the vertical flight phase. In a preferred embodiment, the diameter of the electric fans 110 is 0.6 m, and each electric fan 110 has 6 blades. In such a configuration, the combined thrust provided by all the electric fans 110 is 20% of the maximum takeoff weight, which is enough to obtain good control of the rotorcraft 100. In another embodiment, a variable pitch mechanism is provided to keep the electric fans 110 rotating at a constant speed and generate positive and negative vertical forces. This embodiment is ideal from the control point of view but requires a step change mechanism that complicates the design. When the rotorcraft 100 exceeds a certain transition speed, the electric fans 110 are turned off, and the pitch and roll control is obtained by elevators 112C′, 112D′ provided on the rear wing-like extensions 112C, 112D, which can move differentially or in tandem. The yaw control is provided by rudders 114A installed in the vertical stabilizers 114 of the extensions 112C, 112D.

In accordance with an embodiment of the present invention, there are four positions and two tandem motors for each fan 110 for a total of eight fans. The tandem configuration is proposed for safety reasons in case one electric motor fails. The design can withstand the failure of even all the fans and still manage to survive if it can accelerate to gyrocopter mode without hitting an obstacle or if two 80 hp main rotor motors are installed. If two 40 hp motors are installed, instead of two 80 hp motors, it would have to land in gyrocopter mode for maximum safety, but it could also land in helicopter mode if wind drift is acceptable.

For on-ground maneuvering the rotorcraft 100, the rotorcraft 100, further comprises a fixed mono-wheel 118 provided at an operative bottom surface of the cockpit 102 for rotating the rotorcraft 100 in its own axis into the headwind without the need for additional space as it can pivot on its axis and to decrease the landing gear complexity-maintenance weight penalty. Furthermore, outrigger wheels 120 on the tips of the extensions 112C, 112D for ground stability.

In one embodiment, the rotorcraft 100 is provided with 100% autonomous autopilot with manual fly-by-wire override for safety.

In accordance with the present invention, the rotorcraft 100 includes at least two rotors and propeller-fans for attitude control. There is no need for a cyclic swash plate or a variable pitch control mechanism for the rotors and all that complexity, risk, maintenance, weight and cost. The same is also not needed for the horizontal propeller fan 116, thereby dramatically reducing the piloting skills or autopilot software complexity and reducing costs, maintenance, failures, and complexity and increasing dispatch availability rates.

Although embodiments for the rotorcraft have been described in language specific to structural features and/or methods, it is to be understood that the invention is not necessarily limited to the specific features or methods described. Rather, the specific features and methods are disclosed as exemplary embodiments of the system and the method described herein.

1. A rotorcraft comprising:
a cockpit for at least one passenger;
a pair of concentric shaft electric motors configured to differentially control at least one overhead rotor in a counter-rotating configuration, and wherein each rotor supports a plurality of blades;
a plurality of wing-like extensions coupled and projected outward the cockpit; and
a plurality of electric fans vertically pointed;
wherein the electric fans are coupled at the distal end of the wing-like extensions.

2. The rotorcraft according to claim 1, wherein the blades can be low aspect ratio blades with wide blade chords.

3. The rotorcraft according to claim 1, wherein the plurality of electrical fans allow pivoting.

4. The rotorcraft according to claim 1, wherein each electrical fan includes six blades.

5. The rotorcraft according to claim 1, wherein each electrical fan is activated either by at least one at a time or collectively.

6. The rotorcraft according to claim 1, wherein each wing-like extension also includes vertical stabilizers and/or rudders.

7. The rotorcraft according to claim 1, wherein at least two wing-like extensions also include horizontal stabilizers and elevators.

8. The rotorcraft according to claim 1, wherein the rotorcraft utilizes a fixed pitch main rotors system.

9. The rotorcraft according to claim 1, wherein the rotorcraft also includes a horizontal thrust propeller fan provided at a rear operative end of said rotorcraft.

10. The rotorcraft according to claim 9, wherein the horizontal propeller is powered either by an internal combustion engine or by an electric motor.

11. The rotorcraft according to claim 9, wherein the horizontal propeller fan is powered by a fuel turbine generator.

12. The rotorcraft according to claim 9, wherein the horizontal propeller fan can be ringed propeller.
